(19) United States
(12) Patent Application Publication
(10) Pub. No.: US 2006/0152602 A1
(43) Pub. Date: Jul. 13, 2006

(54) RECORDING AND REPRODUCING APPARATUS

(75) Inventors: TOSHINORI KOBA, Kawasaki-shi (JP); YASUSHI KASAI, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/275,483

(22) Filed: Jan. 9, 2006

(30) Foreign Application Priority Data
Jan. 13, 2005 (JP) 2005-006667
Jun. 3, 2005 (JP) 2005-164412

(51) Int. Cl. H04N 5/76

(52) U.S. Cl. 348/231.99

(57) ABSTRACT

A recording and reproducing apparatus includes: a first recording and reproducing unit that records and reproduces first information data onto/from a first recording medium; a second recording and reproducing unit that records and reproduces second information data onto/from a second recording medium; a selection unit that arbitrarily selects information data which should be recorded onto the first recording medium from the second information data recorded on the second recording medium; and a control unit that controls the first recording and reproducing unit and the second recording and reproducing unit so that the second information data selected by the selection unit are reproduced from the second recording medium to be recorded onto the first recording medium and then a finalize process is executed on the first recording medium in response to that an instruction to execute the finalize process is provided to the first recording medium to enable the information data recorded on the first recording medium to be reproduced in another apparatus.

### BACKGROUND OF THE INVENTION

1. Field of the Invention

The present invention relates to an apparatus that can record image data onto a plurality of media.

2. Description of the Related Art

Conventionally, video cameras that photograph moving images and record them onto magnetic tapes are known. In recent years, a lot of such video cameras have memory card slots and record data of moving images and still images onto not only magnetic tapes but also memory cards.

In recent years, video cameras that record image data onto disk media such as DVD (Digital Versatile disk) instead of the magnetic tapes are known (for example, see Japanese Patent Application Laid-Open No. 2004-235679). DVD includes a disk which enables repetitive recording, (rewritable disk) (DVD-RW, DVD-RAM and the like), and a write-once-read-many disk (DVD-R). Since in case of DVD-R and DVD-RW, images recorded by normal DVD video players can be reproduced by performing finalizing processing, compatibility between different manufactures and different devices is high.

In case of write-once-read-many disks represented by DVD-R, if the finalizing processing is performed once, data cannot be recorded thereonto. That is to say, data cannot be again written onto media even if it has a lot of unused area. Actually, it appears to happen frequently that medium with a lot of unused area should be finalized because reproduction in different devices is necessary.

### SUMMARY OF THE INVENTION

It is an object of the present invention to solve the above problem.

It is another object of the present invention to provide a device which can effectively use recording media in the case where image data are recorded onto a plurality of recording media.

Further, it is still another object of the present invention to provide a device which can effectively use a recording capacity in the case where data are recorded on a write-once-read-many recording medium.

In order to solve the above problems and attain the above objects, the present invention provides a recording and reproducing apparatus comprising: first recording and reproducing means for recording and reproducing first information data onto/from a first recording medium; second recording and reproducing means for recording and reproducing second information data onto/from a second recording medium; selection means for arbitrarily selecting information data which should be recorded onto the first recording medium from the plural information data recorded on the second recording medium; and control means for controlling the first recording and reproducing means and the second recording and reproducing means so that the second information data selected by the selection means are reproduced from the second recording medium and are recorded onto the first recording medium and then a finalize process is executed on the first recording medium, in response to that an instruction to execute the finalize process is provided to the first recording medium, to enable information data recorded on the first recording medium to be reproduced in another apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating a recording and reproducing apparatus according to a first embodiment;

FIG. 2 is a flowchart illustrating a finalizing operation according to the first embodiment;

FIG. 3 is a diagram explaining an example of screen display in the first embodiment;

FIG. 4 is a flowchart illustrating an image selection operation according to the first embodiment;

FIG. 5 is a block diagram explaining a constitution of the recording and reproducing apparatus according to a second embodiment;

FIG. 6 is a flowchart illustrating the image selection operation according to the second embodiment;

FIG. 7 is a block diagram explaining a constitution of the recording and reproducing apparatus according to a third embodiment;

FIG. 8 is a diagram explaining a modified example depending on a use in the third embodiment;

FIG. 9. is a flowchart illustrating the image selection operation according to the third embodiment;

FIG. 10 is a block diagram illustrating the recording and reproducing apparatus according to a fourth embodiment;

FIG. 11 is a flowchart illustrating copy area setting process in the fourth embodiment;

FIG. 12 is a diagram illustrating a selection screen in the copy area setting process;

FIG. 13 is a flowchart illustrating a copy area automatic setting process;

FIG. 14 is a flowchart illustrating a copy area manual setting process;

FIG. 15 is diagram illustrating a copy area capacity setting state screen;

FIG. 16 is a diagram illustrating the copy area capacity setting state screen; and

FIG. 17 is a diagram illustrating a display example of recordable time.

### DESCRIPTION OF THE PREFERRED EMBODIMENTS

Preferred embodiments of the present invention are explained in detail below with reference to the accompanying drawings.

### First Embodiment

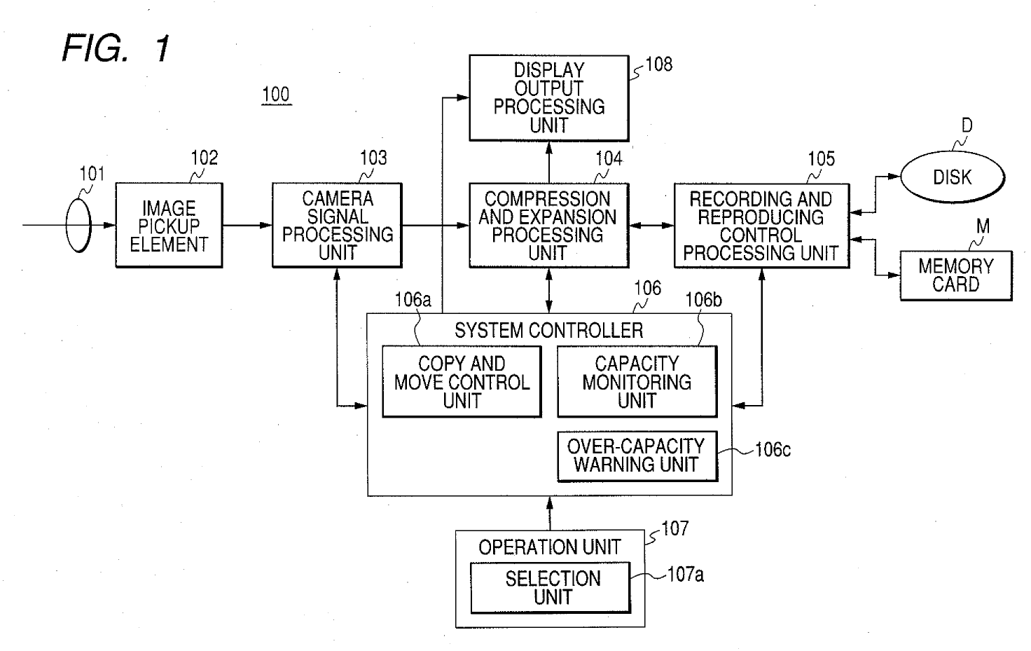

FIG. 1 is a block diagram explaining a constitution of a recording and reproducing apparatus according to a first embodiment.

A recording and reproducing apparatus 100 shown in FIG. 1 is a device which can record and reproduce image data onto a recording medium (optical disk), from which data can be reproduced by means of another reproducing apparatus by performing the finalizing processing, and another recording medium (memory card).

In FIG. 1, 101 denotes an optical system such as a lens, and image pickup light which enters the optical system 101 is converted onto an electric signal by an image pickup element 102. 103 denotes a camera signal processing unit, which executes a signal process such as digital conversion of the electric signal output from the image pickup element 102 or a white balance process. 104 denotes a compression and expansion processing unit, which encodes a signal received by the camera signal processing unit 103 at the time of recording to convert the encoded signal onto a suitable format for recording. At the time of reproducing, the compression and expansion processing unit decodes data read from the recording medium to expand their information amount. For example, moving image data are encoded by the MPEG 2 system, and still image data are encoded by JPEG system.

105 denotes a recording and reproducing control processing unit, which controls writing of data onto a recording medium and reading of data from a recording medium. D denotes a system controller which includes a CPU, a memory and the like and controls state management and the execution processing in the respective processing units. 107 denotes an operation unit, which includes a main body button, a switch, a remote controller or the like which is used by a user in order to instruct the apparatus to execute and stop various operations such as starting and ending of photographing and finalization, and make various setting in the apparatus. Selection of a recording medium or the like is performed by the operation unit 107.

108 denotes a display output processing unit, which receives an image signal output from the compression and expansion processing unit 104 and a menu display signal or the like from the system controller D to perform display on a display device. Not particularly shown in the drawing, but a microphone provided to the main body is used, so that a sound can be recorded according to the approximately similar operation as the image signal. At the time of recording an image (moving image), normally a sound is also recorded, and the compression and expansion processing unit 104 multiplexes the image and the sound.

D denotes a disk recording medium such as a DVD, and DVD-R or DVD-RW is used in this embodiment. The disk medium is finalized so that image data can be reproduced by a different DVD player. M denotes a memory card, which contains a semiconductor memory which can store still image data.

Data can be copied from the memory card M to the optical disk D. In this case, data specified by the operation unit 107 are read out from the memory card M by the recording and reproducing control processing unit 105, to be written onto the optical disk D.

107a denotes a selection unit provided to the operation unit 107, which selects still image data to be copied from still image data which are recorded on the memory card M and can be copied. 106a denotes a copy and move control unit included in the system controller 106, which controls the recording and reproducing control processing unit 105 so as to control copying of data between the memory card M and the optical disk D. 106b denotes a capacity monitoring unit, which compares a recordable capacity of the disk D, the capacity of the still image data recorded in the memory card M and the capacity of the still image data selected by the selection unit 107a. 106c denotes an over-capacity warning unit, which warns the user that the capacity of the selected still image data exceeds a remaining capacity of the disk.

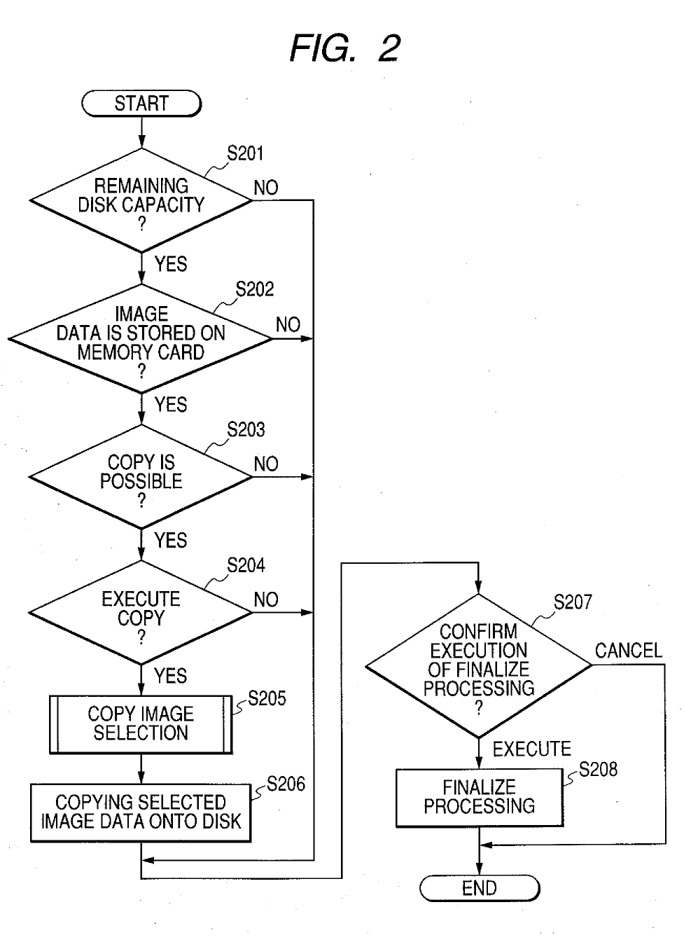

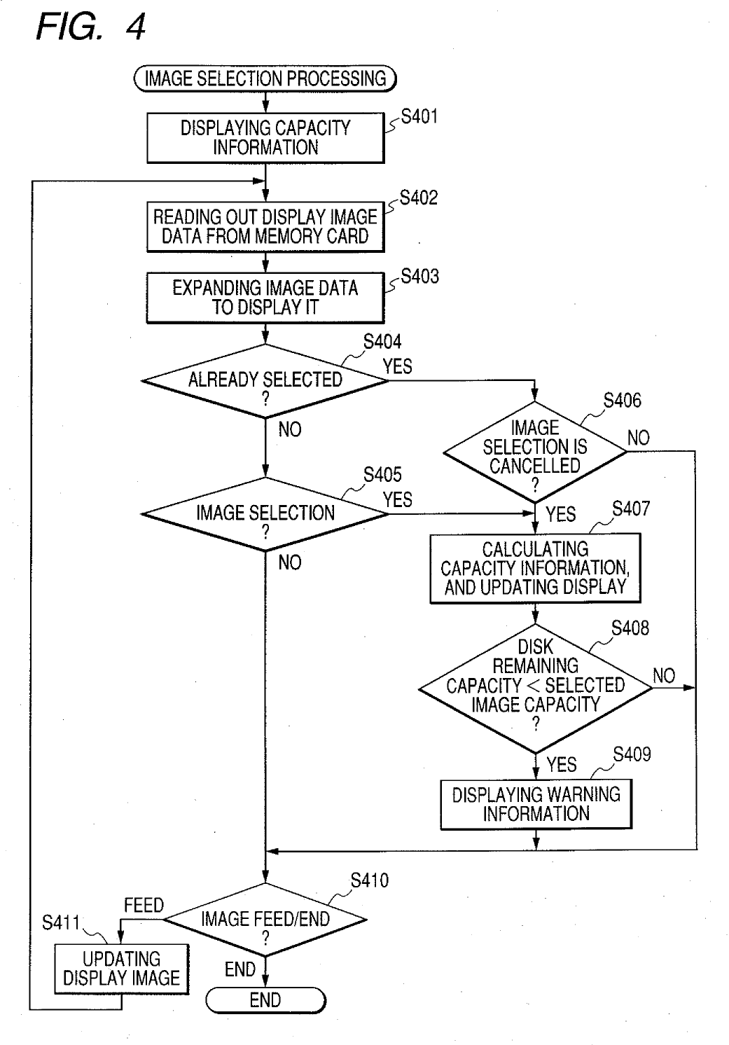

FIGS. 2 and 4 are flowcharts explaining operations in this embodiment according to the finalizing process.

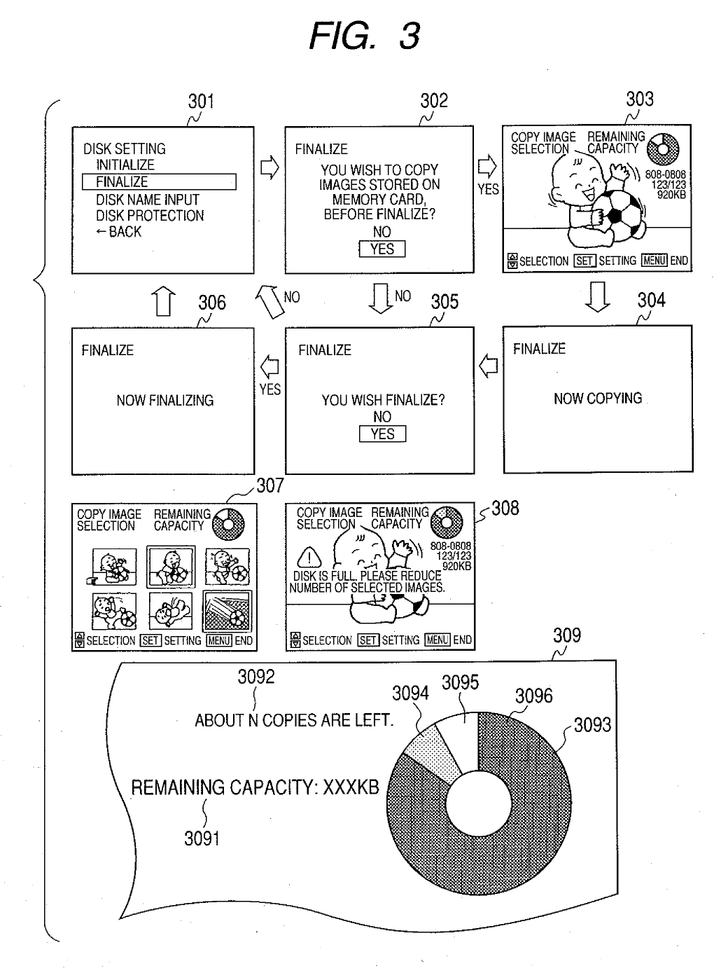

In this embodiment, at the time of finalizing the disk D, still image data recorded on the memory card M can be selected to be copied onto the disk D. FIG. 3 is a diagram illustrating an example of screen display in the display output processing unit 110 at the time of finalize. This is explained according to the flowchart below.

A user operates the operation unit 107 so as to display a screen 301 of FIG. 3. The user operates the operation unit 107 using the screen 301 so as to select a finalize instruction. When the finalize is instructed, the flow of FIG. 2 is started.

In FIG. 2, the capacity monitoring unit 106b confirms remaining capacity of an optical disk (step S201). When a recordable area does not remain, the sequence goes to step S207. When a recordable area remains, the capacity monitoring unit 106b confirms the capacity of all the still image data stored on the memory card M (step S202).

When the capacity is 0, namely, the still image data are not stored, the sequence goes to step S207. When the capacity is not 0, the remaining capacity of the disk D confirmed at step S201 is compared with the capacity of the still image data, which is the smallest among those of the still image data confirmed at step S202 (step S203). When one or more still image data cannot be copied, the sequence goes to step S207.

When the still image data can be copied, a screen 302 in FIG. 3 is displayed and an inquiry is made to the user about whether the copying is performed (step S204). When the copying is not performed, the sequence goes to step S207. When the copying is performed, a still image desired to be copied is selected (step S205). The copy image selection process is explained with reference to a flowchart of FIG. 4.

In FIG. 4, capacity information such as the remaining capacity of the disk obtained at step S201 in FIG. 2 and the capacity of display image data is displayed (step S401).

Leading still image data are read out from the still image data recorded on the memory card M (step S402) and are expanded to be displayed (step S403). A state of the display screen at this time is shown in 303 of FIG. 3.

In this state, a confirmation is made as to whether the displayed still image is already selected, and the selection status is displayed (step S404). When the still image is already selected, a determination is made as to whether the selection of the currently displayed image is canceled (step S406). When the selection is canceled, the capacity of the still image data whose selection is canceled is subtracted from the capacity of all the currently selected still image data, so that capacity information is calculated and the display is updated (step S407).

On the other hand, when the still image is not yet selected at step S404, the sequence waits for a user's selected result (step S405). When the user selects a displayed image, the sequence goes to step S407, wherein the capacity of the newly selected still image data is added to the capacity of all the currently selected still image data so that the capacity information is calculated and the display is updated.

After the capacity of the image data selected at step S407 is calculated, the remaining capacity of the disk D is compared with the capacity of the selected image data (step S408). When the capacity of the selected image data exceeds the remaining capacity of the disk D, warning information shown at 308 of FIG. 3 is displayed (step S409).

When the capacity of the selected image data is smaller than the remaining capacity of the disk D at step S408, or when an image is not selected at step S405, the sequence goes to step S410 to wait for updating of the display image or end of the selection.

When the display image is instructed to be updated (fed), setting is made so that next still image data are read out from the memory card M, and the sequence returns to step S402 (step S411). When ending is instructed, the process flow is ended, the sequence goes to step S206 of FIG. 2.

309 in FIG. 3 shows a display example of the capacity information at step S401. In 309, 3091 shows a remaining capacity of the disk represented by a numerical value, 3092 shows a remaining number of selectable still images with respect to the remaining capacity of the disk. 3093 is a graphic showing the disk. 3096 shows a recorded capacity, 3094 shows a selected image capacity, and 3095 shows a writable remaining capacity. At step S407, these displays are updated.

The still image data are read out from the memory card M one by one at step S402, but a plurality of still images are read out to be displayed on one screen as shown in 307 of FIG. 3.

When the copy image selection step at step S205 in FIG. 2 is ended, the copy and move control unit 106a reads out the still image data selected at step S205 from the memory card M and copies them to the disk D (step S206). The display screen at this time is shown in 304 of FIG. 3.

Not the copy process but moving process may be performed. In this case, after the still image data are written onto the disk D, they are deleted from the memory card M.

When the copying is ended, the screen 305 of FIG. 3 is displayed, a confirmation is made for a user as to whether finalize is performed (step S207). When the finalize is not performed, the process is ended.

When the finalize process is performed, necessary data are written onto the disk D and then the finalize process is performed (step S208). The state of the display screen at this time is shown as 306 of FIG. 3.

Step S207 is not essential, but when finalize is performed in the case of a write-once disk, rewriting cannot be performed. For this reason, it is desirable that the confirmation is made.

In this embodiment, when the finalize is instructed, the still image data stored in the memory card can be copied onto a vacant area of the disk. For this reason, a vacant area of the disk can be used effectively.

### Second Embodiment

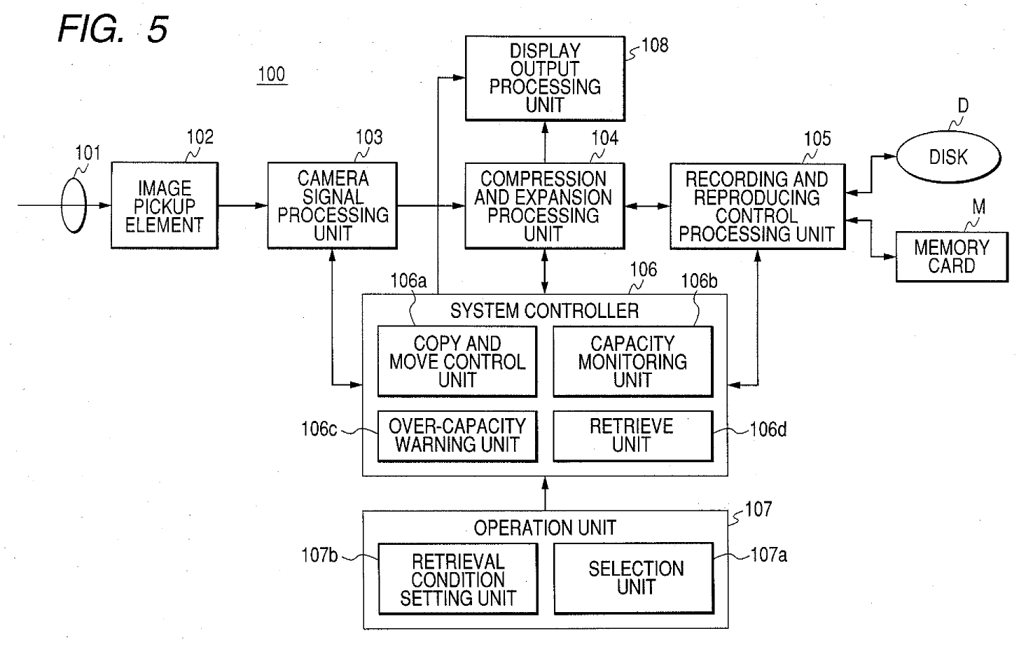

FIG. 5 is a block diagram explaining a constitution of the recording and reproducing apparatus according to a second embodiment. Elements which have the same functions as FIG. 1 are denoted by the same reference numerals, and detailed explanation thereof is omitted.

In FIG. 5, 108d denotes a retrieve unit that retrieves the still image data recorded on the memory card M based on a predetermined condition. 107b denotes a retrieve condition setting unit that sets a condition for retrieve by means of the retrieve unit 106d.

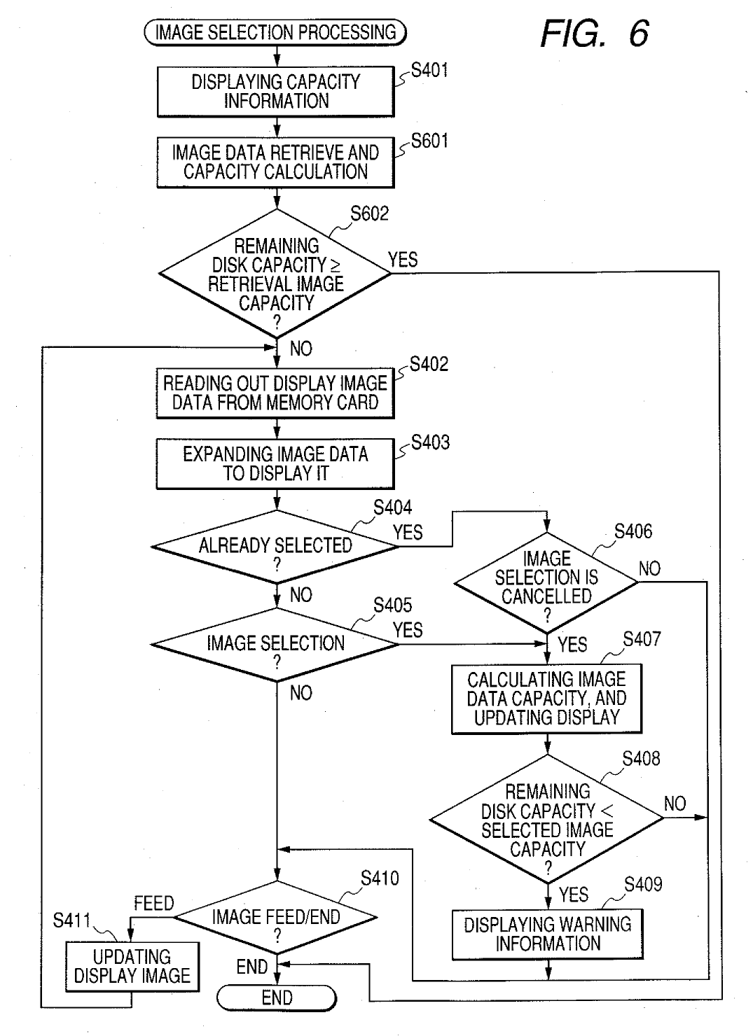

FIG. 6 is a flowchart explaining a copy image selection process at the time of finalize according to the second embodiment, which corresponds to step S205 of FIG. 2. In FIG. 6, the same steps as those in FIG. 4 are denoted by the same reference numerals, and explanation thereof is not described.

In the second embodiment, the user sets conditions such as photographing date previously recorded on the disk D using the retrieve condition setting unit 107b. For example, the retrieve condition setting unit 107b can set photographing (recording) date of still image data. As a result, the retrieve unit 106d retrieves still image data photographed on the same or close date as or to the photographing (recording) date of the image data recorded on the disk D from the still image data recorded on the memory card M.

In FIG. 6, after capacity information is displayed (step S401), the still image data recorded on the memory card M are retrieved according to the condition set by the retrieve condition setting unit 107b. The capacity of all the retrieved still images as copy candidates is calculated (step S601).

The calculated capacity of all the still image data as the copy candidates is compared with the remaining capacity of the disk (step S602). When the capacity of all the still image data is equal to or less than the remaining capacity of the disk D, all the still image data of the copy candidates can be recorded on the disk D, and thus the process is ended. When the capacity of the still image data exceeds the remaining capacity of the disk, the sequence goes to step S402.

The process flow after step S402 is the same as that in the first embodiment. The image to be displayed at step S403 is only the still image data of the copy candidates selected as a result of the retrieval at step S602.

Step S602 is deleted, and a user may further select a still image of a copy candidate from the still image data selected as a result of the retrieval.

As the retrieve condition, instead of the date, for example, a file size of image data recorded on a card or resolution of an image can be set.

### Third Embodiment

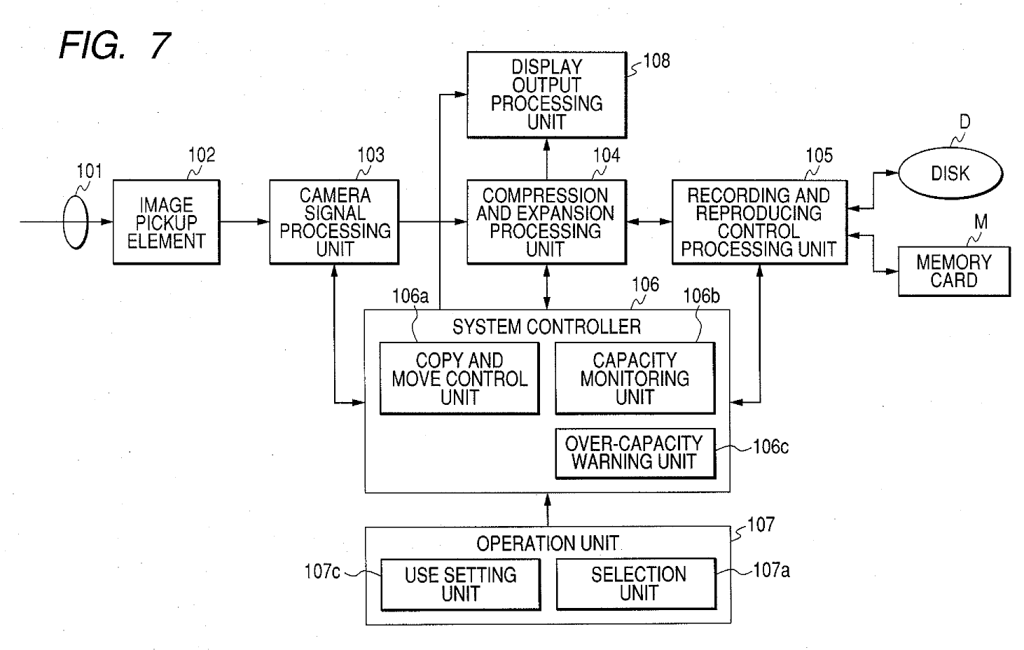

FIG. 7 is a block diagram explaining a constitution of the recording and reproducing apparatus according to a third embodiment. The elements having the same functions as those in FIG. 1 are denoted by the same reference numerals, and detailed explanation thereof is not described.

In the third embodiment, a use setting unit 107c for setting a use for the disk D after finalize, is provided. Concretely, the user sets whether the disk D is used only in a DVD player or also in a personal computer (PC) by the use setting unit 107c. When image data recorded on the memory card M are copied onto the disk D, the copy and move control unit 106a converts its format according to the use set by the use setting unit 107c.

In this embodiment, moving image data encoded by the MPEG system are recorded on the optical disk D according to a DVD video mode, and still image data encoded by the JPEG system are recorded on the memory card M. When the disk D is subjected to finalize processing, the format of the recorded data is the same as that of DVD video disks on the market, and thus the data can be directly reproduced on general DVD video players.

On the other hand, when still image data of the JPEG format are recorded on the disk D like the above-mentioned embodiment, the still image data cannot be reproduced in general DVD video players. For this reason, in this embodiment, when the still image data recorded on the memory card M are copied onto the disk D, the still image data on a plurality of pictured are converted onto moving image data of a slide show format. After the converted moving image data are encoded by the MPEG system, the data are recorded on the disk D in a data format according to the DVD video mode. Hereinafter, the moving image data which are obtained by converting the still image data into the MPEG type in such a manner, are called as a photo movie.

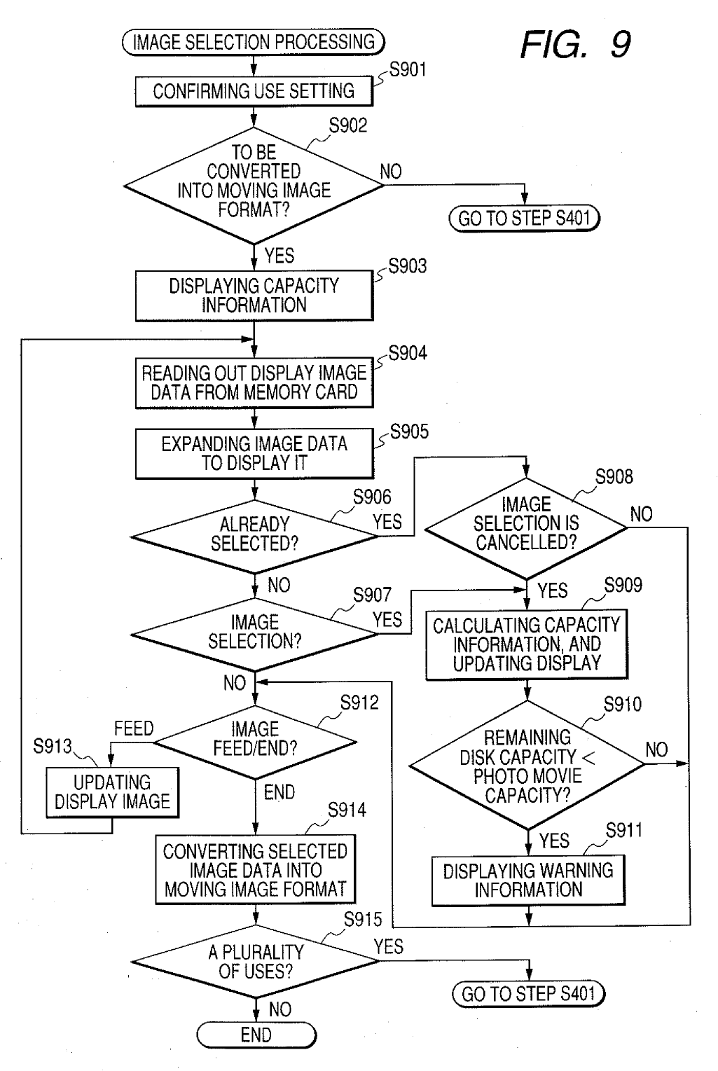

FIG. 9 is a flowchart illustrating the copy image selection process in the third embodiment, which corresponds to step S205 of FIG. 2. In FIG. 9, the processes at steps S904 to S909 and S911 to 913 are similar to those at steps S401 to 407 and S409 to 411, respectively.

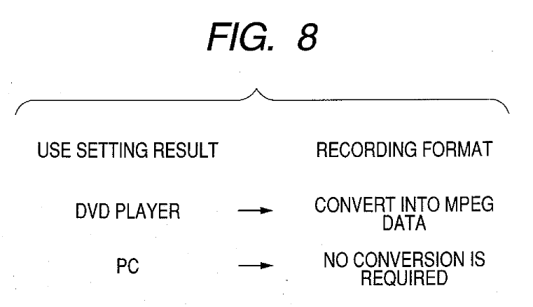

In FIG. 9, a use set by the use setting unit 107b is confirmed (step S901). A determination is made as to whether still image data are converted onto a moving image format according to a result of setting and a correspondence table shown in FIG. 8 (step S902).

When the use in the PC is set, still image data may be directly copied, and thus the sequence goes to step S401 in FIG. 4 so that an image of a copy candidate is selected similarly to the first embodiment.

When reproduction in a DVD player is selected, similarly to the processes at steps S401 to S407 in FIG. 4, the still image data recorded on the memory card M are read out to be displayed. When selection of a displaying image or release of selection is instructed, the capacity of data obtained by converting the currently selected still image data onto the moving image format (MPEG format) is calculated (step S909). The calculated capacity of the MPEG data is compared with the remaining capacity of the disk, and when the capacity of the MPEG data exceeds the remaining amount of the disk, warning information is displayed.

Thereafter, when selection of an image of copy candidate is ended, while the display image is being updated, the selected still image data are sequentially read out from the memory card M and are decoded and encoded by the MPEG system so that photo movie data are created. The photo movie data are recorded on the disk D (step S914).

When the use in PC is also set, the sequence goes to step S401 (step S915). When only the use in a DVD player is set, the process is ended.

In such a manner, after finalize, the still images in the memory card M can be copied or moved to the optical disk D in a format required by the user.

In this embodiment, since the photo movie data are recorded on the disk D at step S914, they are not written onto the disk D at step S206 in FIG. 2.

In this embodiment, at step S203 in FIG. 2, the capacity of data obtained by converting the still image data stored on the memory card M onto photo movie may be compared with the remaining capacity of the disk.

In the first to the third embodiments, the data stored on the memory card M are explained as still image data, but the data may be moving image data.

According to the embodiments, when the disk has remaining capacity at the time of finalize, the still image data recorded on the card can be easily copied to the disk, so that the disk can be used economically.

Image data recorded on the disk are easily selected from the still image data recorded on the memory card, to be copied to the disk.

Since a data type is suitably converted according to the uses of the disk after finalize, user's time required for confirming a data type or the like is reduced at the time of creating a save disk.

### Fourth Embodiment

In the above embodiments, when the disk has a remaining capacity at the time of finalize, the still image data recorded on the memory card are copied to the disk.

When the remaining capacity of the disk is small, user's desired still image data or all the still image data in the still image data recorded on the memory card cannot be recorded onto the disk.

In an embodiment explained below, therefore, an area where the still image data recorded on the memory card are copied is previously secured on the disk.

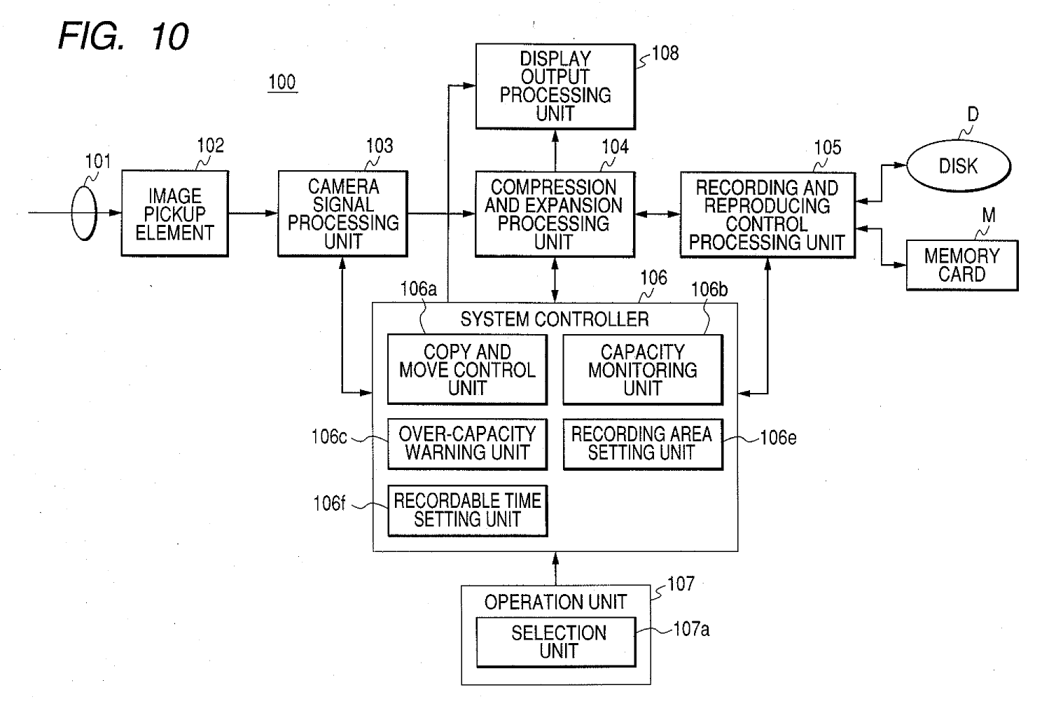

FIG. 10 is a diagram illustrating a constitution of the recording and reproducing apparatus 100 according to a fourth embodiment, and the function blocks which are the same as those in FIGS. 1, 5 and 7 are denoted by the same reference numerals, and detailed explanation thereof is not described.

In FIG. 10, 106e denotes a recording area setting unit that previously sets a recording area on the disk D where still image data recorded on the memory card M are recorded. Specifically, the recording area setting unit 106e sets a recording area corresponding to a storage capacity of the memory card M detected by the capacity monitoring unit 106b as the recording area for copy on the disk D. In another manner, the recording area which is set according to a size set arbitrarily by the user is set as the recording area for copy on the disk D. 106f denotes a recordable time setting unit that sets recordable time of the moving image data on the disk D based on a vacant capacity of the disk D detected by the capacity monitoring unit 106b and the recording area set by the recording area setting unit 106e.

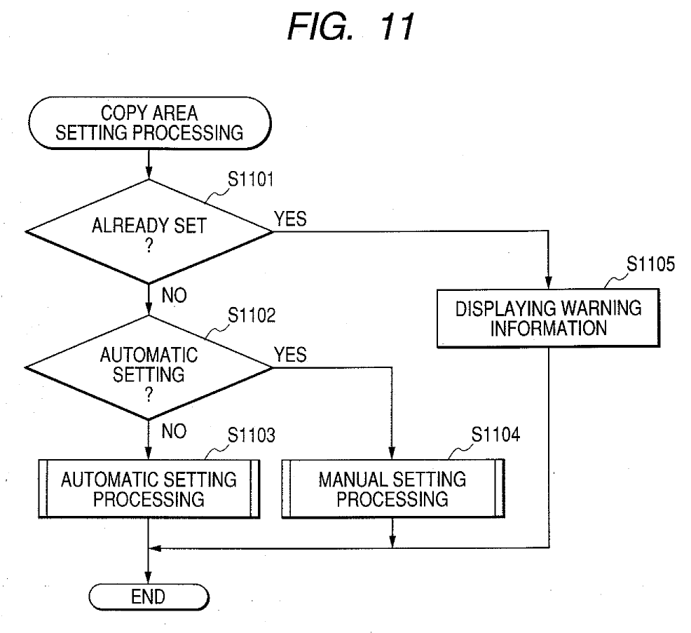

Next, the process for setting a copy area on the disk D in this embodiment is explained below. FIG. 11 is a flowchart illustrating the copy area setting process.

In this embodiment, when the user operates the operation unit 107 to instruct setting of a copy area, the process in FIG. 2 is executed.

In FIG. 2, a determination is made as to whether the copy area is already set on the attached disk D (step S1101). In this embodiment, data representing that the copy area is set are stored in management information of the disk D, and the determination is made based on the management information.

As a result of the determination, when the copy area is already set, warning information representing the set state is displayed, and the process is ended (step S1105).

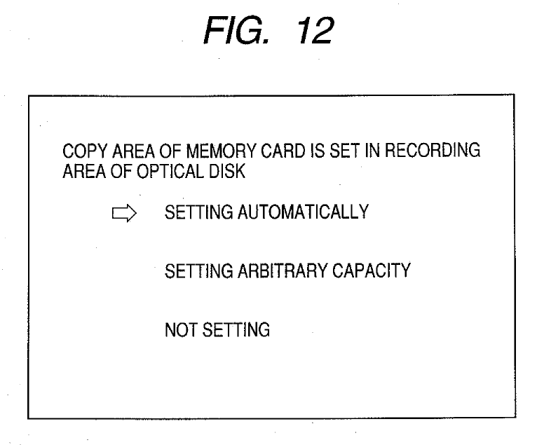

When the copy area is not yet set, a screen shown in FIG. 12 is displayed, and the sequence waits for user's selection whether automatic setting is made (step S1102). When the user operates the operation unit 107, automatic setting or arbitrary capacity setting is selected.

When the automatic setting is selected, the sequence goes to an automatic setting process at step S1103, and when the arbitrary capacity setting is selected, the sequence goes to a manual setting process at step S1104.

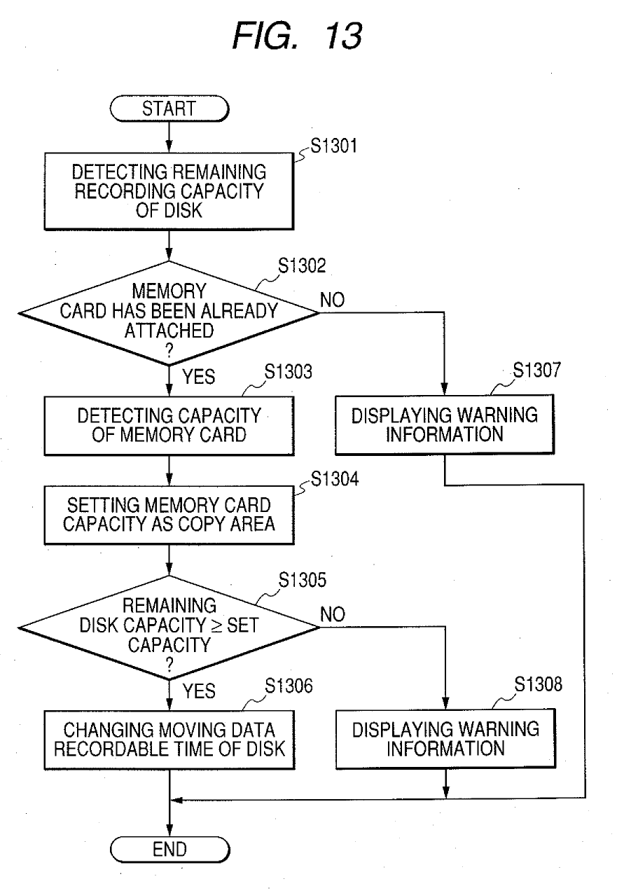

FIG. 13 is a flowchart illustrating the automatic setting process at step S1103.

The capacity monitoring unit 106b detects a vacant capacity of the disk D (step S1301).

A determination is made as to whether the memory card M is attached (step S1302). As a result, when the memory card M is not attached, warning information representing this state is displayed and the process is ended (step S1307). When the memory card M is attached, the storage capacity of the memory card M is detected (step S1303).

The recording area setting unit 106e sets a recording area whose capacity is the same as the storage capacity of the memory card M detected at step S1303 as a copy area (step S1304).

The vacant capacity of the disk D is compared with the recording area set by the recording area setting unit 106e, and a determination is made as to whether the vacant capacity of the disk D is equal to or more than the recording area set by the recording area setting unit 106e (step S1305).

As a result, when the vacant capacity of the disk D is equal to or more than the recording area, the recordable time setting unit 106f subtracts the capacity of the recording area from the vacant capacity of the disk D to calculate a recordable capacity of moving image data. The recordable time of the moving image data are changed based on the calculated recordable capacity (step S1306).

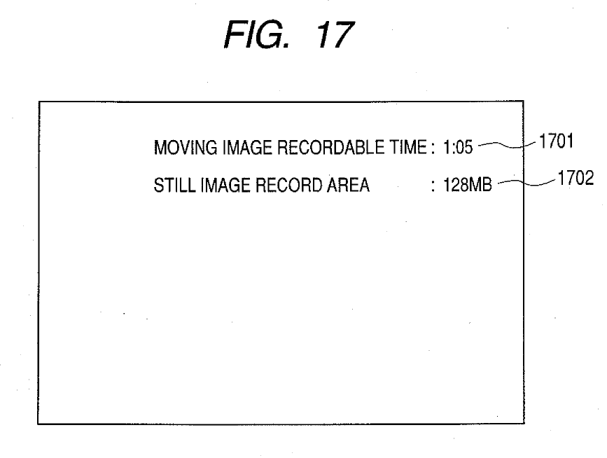

FIG. 17 is a diagram illustrating a display example of the recordable time of the moving image data and the copy area.

As a result of the determination at step S1305, when the vacant capacity of the disk D is smaller than the recording area, this state is output to the display and output unit 108, and warning is given to the user and the process is ended (step S1308).

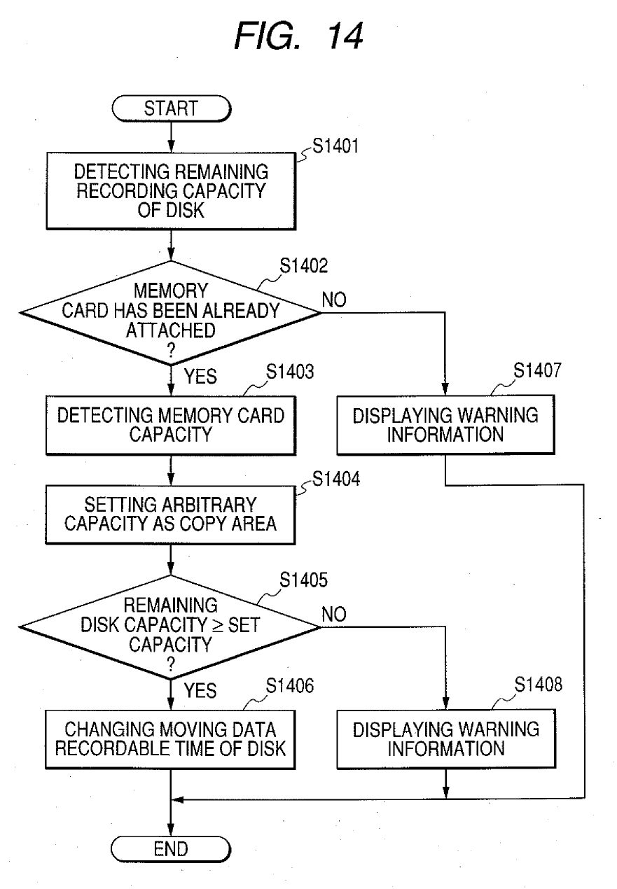

FIG. 14 is a flowchart illustrating the manual setting process at step S1104.

The capacity monitoring unit 106b detects the vacant capacity of the disk D (step S1401).

A determination is made whether the memory card M is attached (step S1402). As a result, when the memory card M is not attached, warning information representing this state is displayed so that the process is ended (step S1407). When the memory card M is attached, the storage capacity of the memory card M is detected (step S1403).

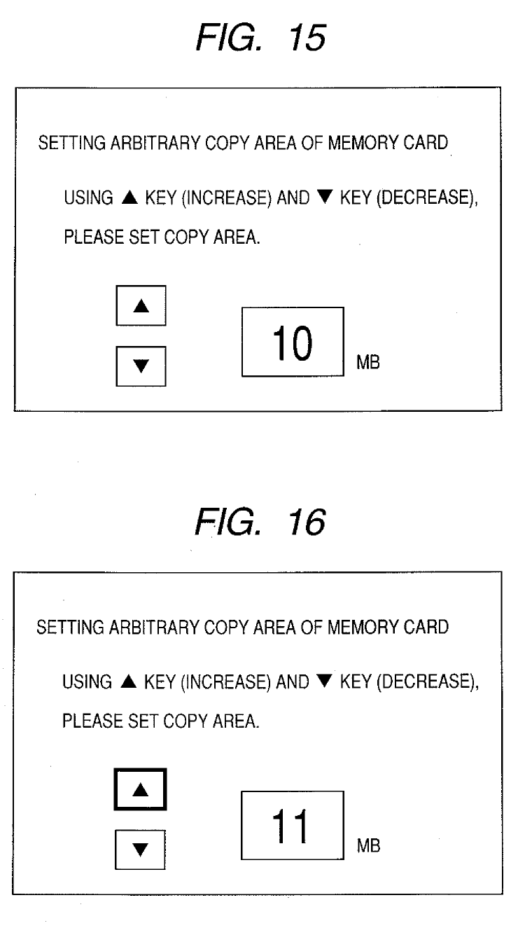

The screen for setting capacity shown in FIG. 15 or 16 is displayed, and the sequence waits for setting of the size of copy area by the user. The recording area whose capacity is the same as the storage capacity set by the user is set as a copy area (step S1404).

FIGS. 15 and 16 are diagrams illustrating the recording area setting screen. FIG. 16 illustrates a case where the user operates “▴” key (increase) in the drawing so as to increase the recording area from an input value 10 MB to an input value 11 MB on the input screen of FIG. 15. The “▴” key (increase) and “▾” key (decrease) are controlled by the operation unit 107.

The vacant capacity of the disk D is compared with the set recording area, and a determination is made as to whether the vacant capacity of the disk D is equal to or more than the set recording area (step S1405).

As a result, when the vacant capacity of the disk D is equal to or more than the recording area, the recordable time setting unit 106f subtracts the set capacity of the recording area from the vacant capacity of the disk D to calculate the recordable capacity of moving image data. The recordable time of the moving image data is updated based on the calculated recordable capacity (step S1406).

As a result of the determination at step S1405, when the vacant capacity of the disk D is smaller than the recording area, this state is output to the display and output unit 108, and warning is given to the user and the process is ended (step S1408).

After the copy area is secured on the disk D in such a manner, the system controller 106 monitors the recordable capacity of the disk D while the moving image data are being recorded onto the disk D, and stops the recording at the time of running out a recordable remaining capacity.

The other processes are similar to those in the first to the third embodiments, but since the copy area is previously set on the disk D in this embodiment, all still image data recorded on the memory card M can be copied to the disk at the time of finalize.

The recording area of the still image data on the memory card can be secured on the disk, and the user can record moving image data without minding the vacant capacity of the disk. As a result, the optical disk 107 can be utilized as not only a recording medium of moving image data but also as a recording medium for saving still image data.

This embodiment explains the case where moving image data and still image data are recorded and reproduced on/from an optical disk and a semiconductor memory card. Instead of optical disks and memory cards, however, another recording media may be used, and another information data may be recorded and reproduced instead of moving image data and still image data.

Information relating to the copy area secured in the disk is stored in management information on the disk, and further the information can be saved in a nonvolatile memory, for example, in the recording and reproducing apparatus 100.

The object of the present invention can also be achieved by providing a storage medium storing program codes for performing the aforesaid processes to a recording and reproducing apparatus, reading the program codes, by a CPU or MPU of the image sensing system or apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM, and computer network, such as LAN (local area network) and WAN (wide area network), can be used for providing the program codes.

Furthermore, besides aforesaid functions according to the above embodiments are realized by executing the program codes which are read by a CPU of the recording and reproducing apparatus, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted onto the recording and reproducing apparatus or in a memory provided in a function expansion unit which is connected to the recording and reproducing apparatus, CPU or the like contained in the function expansion card or unit performs a part or entire process in accordance with designations of the program codes and realizes functions of the above embodiments.

The present invention is not limited to the above embodiments and various changes and modifications can be made within the spirit and scope of the present invention. Therefore to apprise the public of the scope of the present invention, the following claims are made.

This application claims priority from Japanese Patent Application No. 2005-006667 filed Jan. 13, 2005 and Japanese Patent Application No. 2005-164412 filed Jun. 3, 2005 which are hereby incorporated by reference herein.

What is claimed is:

1. A recording and reproducing apparatus, comprising:
first recording and reproducing means for recording and reproducing first information data onto/from a first recording medium;
second recording and reproducing means for recording and reproducing second information data onto/from a second recording medium;
selection means for arbitrarily selecting information data which should be recorded onto the first recording medium from the plural information data recorded on the second recording medium; and
control means for controlling the first recording and reproducing means and the second recording and reproducing means so that the second information data selected by the selection means are reproduced from the second recording medium and are recorded onto the first recording medium and then a finalize process is executed on the first recording medium, in response to that an instruction to execute the finalize process is provided to the first recording medium to enable information data recorded on the first recording medium to be reproduced in another apparatus.

2. The recording and reproducing apparatus according to claim 1, further comprising:
comparison means for comparing a capacity of the second information data selected by the selection means with a remaining capacity of the first recording medium,
wherein when the capacity of the second information data selected by the selection means is larger than the remaining capacity of the first recording medium, the control means prohibits recording of the selected second information data onto the first recording medium.

3. The recording and reproducing apparatus according to claim 2,
wherein when the capacity of the second information data selected by the selection means is larger than the remaining capacity of the first recording medium, the control means displays warning information on a display device.

4. The recording and reproducing apparatus according to claim 1,
wherein the control means includes retrieve means for retrieving data which match with a predetermined condition, from the plural second information data recorded on the second recording medium, and
wherein the selection means selects desired second information data from the second information data retrieved by the retrieve means.

5. The recording and reproducing apparatus according to claim 4,
wherein the retrieve means determines the predetermined condition on the basis of additional information of the first information data recorded on the first recording medium.

6. A recording and reproducing apparatus, comprising:
first recording and reproducing means for recording and reproducing first information data onto/from a first recording medium;
second recording and reproducing means for recording and reproducing second information data onto/from a second recording medium;
retrieve means for retrieving information data which match with a predetermined condition, from the plural second information data recorded on the second recording medium; and
control means for controlling the first recording and reproducing means and the second recording and reproducing means so that the second information data retrieved by the retrieve means are reproduced from the second recording medium to be recorded on the first recording medium and then a finalize process is executed on the first recording medium in response to that an instruction to execute the finalize process is provided to the first recording medium to enable the information data recorded on the first recording medium to be reproduced in another apparatus.

7. The recording and reproducing apparatus according to claim 6, further comprising:
comparison means for comparing a capacity of the second information data retrieved by the retrieve means with a remaining capacity of the first recording medium,
wherein when the capacity of the second information data retrieved by the retrieve means is equal to or less than the remaining capacity of the first recording medium, all the retrieved second information data are recorded on the first recording medium, and when the capacity of the second information data retrieved by the retrieve means is larger than the remaining capacity of the first recording medium, some of the retrieved second information data are selected to be recorded on the first recording medium.

8. The recording and reproducing apparatus according to claim 7, further comprising:
selection means for selecting desired second information data from the second information data retrieved by the retrieve means,
wherein when the capacity of the second information data retrieved by the retrieve means is larger than the remaining capacity of the first recording medium, the control means records the second information data selected by the selection means onto the first recording medium.

9. A recording and reproducing apparatus, comprising:
first recording and reproducing means for recording and reproducing first information data onto/from a first recording medium;
second recording and reproducing means for recording and reproducing second information data with a format different from that of the first information data onto/from a second recording medium;
setting means for setting a use of the first recording medium;
converting means for converting the format of the second information data recorded on the second recording medium onto a format of the first information data to create converted information data; and
mode switching means for switching, according to the use set by the setting means, a mode between a first finalize mode for recording the second information data with the format different from the first information reproduced from the second recording medium onto the first recording medium and executing a finalize process on the first recording medium in response to that an instruction to execute the finalize process is provided to the first recording medium to enable the information data recording on the first recording medium to be reproduced in a predetermined reproducing apparatus, and a second finalize mode for recording the converted information data created by the converting means onto the first recording medium and executing the finalize process on the first recording medium is response to that an instruction to execute the finalize process is provided to the first recording medium.

10. The recording and reproducing apparatus according to claim 9,
wherein the first information data and the second information data have different encoding formats, and the converting means converts the encoding format of the second information data into the same encoding format as the encoding format of the first information data.

11. The recording and reproducing apparatus according to claim 10,
wherein when the setting means sets the predetermined reproducing apparatus or an apparatus other than the predetermined reproducing apparatus to be used for the first recording medium, and the mode switching means selects the second finalize mode when the setting means sets the predetermined reproducing apparatus, and selects the first finalize mode when the setting means sets an apparatus other than the predetermined reproducing apparatus.

12. A recording apparatus, comprising:
first recording means for recording first information data onto a first recording medium;
second recording means for recording second information data onto a second recording medium;
recording area setting means for setting a recording area corresponding to a recording capacity of the first recording medium, as a recording area for recording the first information data recorded on the first recording medium onto the second recording medium; and
control means for controlling a recording operation of the second information data onto the second recording medium on the basis of the recording area set by the recording area setting means.

13. The recording apparatus according to claim 12,
wherein the control means calculates a recordable capacity of the second recording medium on the basis of the recording area set by the recording area setting means, and controls the recording operation of the second information data for the second recording medium in accordance with the detected recordable capacity.

14. The recording apparatus according to claim 13,
wherein when the second recording medium runs out of the calculated recordable capacity, the control means stops the recording of the second information data onto the second recording medium.

15. A recording apparatus, comprising:
first recording means for recording first information data onto a first recording medium;
second recording means for recording second information data onto a second recording medium;
recording area setting means for arbitrarily setting a capacity of a recording area for recording the first information data recorded on the first recording medium onto the second recording medium; and
control means for controlling a recording operation of the second information data for the second recording medium on the basis of the recording area set by the recording area setting means.

16. The recording apparatus according to claim 15,
wherein the control means calculates a recordable capacity of the second recording medium on the basis of the recording area set by the recording area setting means, and controls a recording operation of the second information data for the second recording medium in accordance with the detected recordable capacity.

17. The recording apparatus according to claim 16,
wherein when the second recording medium runs out of the calculated recordable capacity, the control means stops the recording of the second information data onto the second recording medium.
